(19) United States
(12) Patent Application Publication
(10) Pub. No.: US 2026/0348317 A1
(43) Pub. Date: Nov. 5, 2026

(54) ENGINE SYSTEM

(71) Applicant: CUMMINS INC., Columbus, IN (US)

(72) Inventors: J. Steven Kolhouse, Columbus, IN (US); Hui Xu, Carmel, IN (US); Ke Wang, Columbus, IN (US)

(73) Assignee: CUMMINS INC., Columbus, IN (US)

(21) Appl. No.: 19/720,051

(22) Filed: Jun. 25, 2026

Related U.S. Application Data
(63) Continuation of application No. PCT/US2024/061358, filed on Dec. 20, 2024.
(60) Provisional application No. 63/614,893, filed on Dec. 26, 2023.

(51) Int. Cl. F02B 37/013; F01N 3/20; F01N 5/04; F02B 29/04

(52) U.S. Cl. CPC F02B 37/013; F01N 3/2066; F01N 5/04; F02B 29/0406; F02B 29/0493; F01N 2340/06

(57) ABSTRACT

An engine system includes a first turbocharger that includes a first compressor that compresses air and a first turbine coupled to the first compressor and that transfers energy from an exhaust to the first compressor. The engine system further includes a second turbocharger that includes a second compressor disposed downstream of the first compressor. The second compressor receives the air from the first compressor and compresses the air. The second turbocharger further includes a second turbine coupled to the second compressor and disposed upstream of the first turbine. The second turbine transfers energy from the exhaust to the second compressor. The engine system further includes an engine disposed downstream of the second compressor and an exhaust aftertreatment system disposed downstream of the first turbine. The exhaust aftertreatment system receives the exhaust from the first turbine and treats the exhaust. The exhaust aftertreatment system includes a selective catalytic reduction catalyst member.

### CROSS-REFERENCE TO RELATED APPLICATION

This application is a bypass continuation of PCT Application No. PCT/US2024/061358, filed Dec. 20, 2024, which claims the benefit of and priority to U.S. Provisional Patent Application No. 63/614,893, filed Dec. 26, 2023, which is incorporated herein by reference in its entirety and for all purposes.

### TECHNICAL FIELD

The present application relates generally to engine systems that include internal combustion engines.

### BACKGROUND

Engine systems may include non-hybrid engine systems and hybrid engine systems. A non-hybrid engine system may include an internal combustion engine. A hybrid engine system may include an internal combustion engine and an electric motor.

### SUMMARY

In one embodiment, an engine system includes a first turbocharger that includes a first compressor that compresses air and a first turbine coupled to the first compressor and that transfers energy from an exhaust to the first compressor. The engine system further includes a second turbocharger that includes a second compressor disposed downstream of the first compressor. The second compressor receives the air from the first compressor and compresses the air. The second turbocharger further includes a second turbine coupled to the second compressor and disposed upstream of the first turbine. The second turbine transfers energy from the exhaust to the second compressor. The engine system further includes an engine disposed downstream of the second compressor. The engine receives the air from the second compressor, combust a mixture of the air and fuel, and provide the exhaust based on combustion of the mixture to the second turbine.

In another embodiment, an engine system includes a first compressor that compresses air and a second compressor disposed downstream of the first compressor. The second compressor receives the air from the first compressor and compresses the air. The engine system further includes an engine disposed downstream of the second compressor. The engine receives the air from the second compressor, combusts a mixture of the air and fuel, and provides exhaust based on combustion of the mixture. The engine system further includes an exhaust aftertreatment system disposed downstream of the engine. The exhaust aftertreatment system receives and treats the exhaust. The exhaust aftertreatment system includes a selective catalytic reduction catalyst member.

In yet another embodiment, an engine system includes a turbocharger that includes a compressor that compresses air and a turbine coupled to the compressor and that transfers energy from an exhaust to the compressor. The engine system further includes an engine disposed downstream of the compressor. The engine receives the air from the compressor, combusts a mixture of the air and fuel, provides the exhaust based on combustion of the mixture to the turbine, and generates an engine torque output. The engine system further includes an exhaust aftertreatment system disposed downstream of the turbine. The exhaust aftertreatment system receives the exhaust from the turbine and treats the exhaust. The exhaust aftertreatment system includes a selective catalytic reduction catalyst member. The engine system further includes a motor coupled to an engine system component via a coupling mechanism. The motor generates a motor torque output. A total torque output includes the engine torque output generated by the engine and the motor torque output generated by the motor.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a schematic diagram of a first engine system according to an example embodiment;

FIG. 2 is a schematic diagram of the first engine system according to another example embodiment;

FIG. 3 is a schematic diagram of the first engine system according to yet another example embodiment;

FIG. 4 is a schematic diagram of a second engine system according to an example embodiment;

FIG. 5 is a schematic diagram of the second engine system according to another example embodiment; and

FIG. 6 is a schematic diagram of the second engine system according to yet another example embodiment.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and systems for engine systems. The various concepts introduced above and discussed in greater detail below may be implemented in any of a number of ways, as the described concepts are not limited to any particular manner of implementation.

Examples of specific implementations and applications are provided primarily for illustrative purposes.

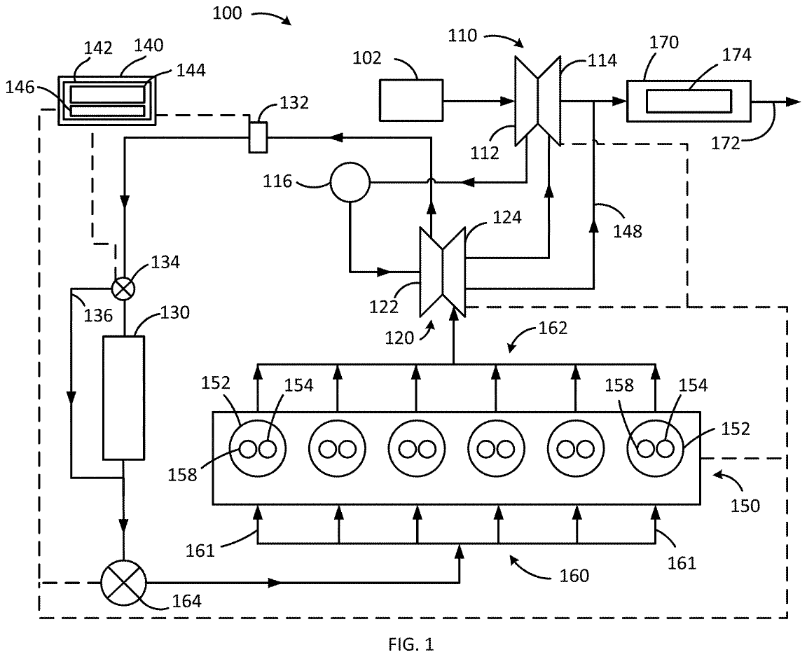

As illustrated in FIGS. 1-3 that depict an engine system 100 (e.g., a first engine system), the engine system 100 comprises a first turbocharger 110 comprising a first compressor 112 configured to compress air and a first turbine 114 coupled to the first compressor 112 and configured to transfer energy from an exhaust to the first compressor 112. The engine system 100 further comprises a second turbocharger 120 comprising a second compressor 122 disposed downstream of the first compressor 112. The second compressor 122 is configured to receive the air from the first compressor 112 and compress the air. The second turbocharger 120 further comprises a second turbine 124 coupled to the second compressor 122 and disposed upstream of the first turbine 114. The second turbine 124 is configured to transfer energy from the exhaust to the second compressor 122. The engine system 100 further comprises an engine 150 disposed downstream of the second compressor 122. The engine 150 is configured to receive the air from the second compressor 122, combust a mixture of the air and fuel, and provide the exhaust based on combustion of the mixture to the second turbine 124. In various embodiments, the engine system 100 further includes an exhaust aftertreatment system 170 disposed downstream of the first turbine 114. The exhaust aftertreatment system 170 is configured to receive the exhaust from the first turbine 114 and treat the exhaust. The exhaust aftertreatment system 170 comprises a selective catalytic reduction catalyst member 174.

The engine system 100 can comprise the first compressor 112 configured to compress air and the second compressor 122 disposed downstream of the first compressor 112. The second compressor 122 is configured to receive the air from the first compressor 112 and compress the air. The engine system 100 can further comprise the engine 150 disposed downstream of the second compressor 122. The engine 150 is configured to receive the air from the second compressor 122, combust a mixture of the air and fuel, and provide exhaust based on combustion of the mixture. The engine system 100 can further comprise the exhaust aftertreatment system 170 disposed downstream of the engine 150. The exhaust aftertreatment system 170 is configured to receive and treat the exhaust. The exhaust aftertreatment system 170 comprises the selective catalytic reduction catalyst member 174.

The engine system 100 may include an air source 102 (e.g., air intake, atmosphere, air cooler, etc.) disposed upstream of the first compressor 112 and configured to provide the air to the first compressor 112.

The engine system 100 may include an intercooler 116 (e.g., a cooler, etc.) disposed downstream of the first compressor 112 and upstream of the second compressor 122. The intercooler 116 is configured to receive the air from the first compressor 112, cool the air, and output the air (e.g., cooled air) to the second compressor 122, such that a temperature of the air (e.g., a first air temperature) received by the intercooler 116 from the first compressor 112 is higher than a temperature of the air (e.g., a second air temperature) released from the intercooler 116. The intercooler 116 may utilized a heat exchange fluid to cool the air. In some embodiments, the heat exchange fluid may substantially include water. In some embodiments, the heat exchange fluid may include engine coolant (i.e., coolant utilized to cool the engine 150, etc.).

In some embodiments, the first turbocharger 110 is a low-pressure turbocharger and the second turbocharger 120 is a high-pressure turbocharger. For example, the first compressor 112 of the first turbocharger 110 may be configured to compress the air at a pressure (e.g., a first air pressure) that is less than a pressure (e.g., a second air pressure) that the second compressor 122 of the second turbocharger 120 is configured to compress the air. As another example, the first turbine 114 of the first turbocharger 110 may be configured to receive the exhaust at a pressure (e.g., a first exhaust pressure) that is less than a pressure of the exhaust (e.g., a second exhaust pressure) that the second turbine 124 of the second turbocharger 120 is configured to receive the exhaust.

In some embodiments, the first turbocharger 110 is a fixed-geometry turbocharger and the second turbocharger 120 is a variable-geometry or a wastegate turbocharger. The combination of the first turbocharger 110 and the second turbocharger 120 (i.e., utilization of the first compressor 112 and the second compressor 122 to compress the air) may provide the benefit of increasing an amount of air that can be delivered to the engine 150, thereby allowing for higher air-to-fuel ratios required by particular fuels (e.g., hydrogen, etc.) and/or allowing for increased injection amounts of fuel (e.g., fuel volume) while maintaining substantially stochiometric combustion to increase the power generated at the combustion stroke. As such, transient response performance (e.g., rise time, delay time, settling time, etc.) of the engine 150 may be improved, particularly at low idle operating condition of the engine 150.

The engine system 100 may include a cooler 130 (e.g., a charge air cooler (CAC), etc.) disposed downstream of the second compressor 122 and upstream of the engine 150. The cooler 130 is configured to receive the air from the second compressor 122, cool the air, and output the air (e.g., cooled air) to the engine 150, such that a temperature of the air (e.g., a third air temperature) received by the cooler 130 from the second compressor 122 is higher than a temperature of the air (e.g., a fourth air temperature) released from the cooler 130.

The engine system 100 may include a sensor 132 disposed downstream of the second compressor 122 and upstream of the cooler 130. The sensor 132 is configured to detect at least one of a temperature or a moisture level of the air provided by the second compressor 122. The engine system 100 may further include a cooler bypass valve 134 disposed downstream of the sensor 132 and upstream of the cooler 130. The cooler bypass valve 134 is configured to selectively adjust a flowrate of the air received by the cooler 130. The engine system 100 may further include a cooler bypass line 136 fluidly coupled to the cooler bypass valve 134. The cooler bypass line 136 is configured to, when the cooler bypass valve 134 is not in a closed position (e.g., an open position, a partially open position, etc.), communicate at least a portion of the air from the cooler bypass valve 134 to downstream of the cooler 130, thereby bypassing the cooler 130.

When the cooler bypass valve 134 is in the closed position, the cooler bypass valve 134 is configured to communicate the air to the cooler 130 and prevent the air from being received by the cooler bypass line 136 (e.g., about 100% of the air flowrate is received by the cooler 130 and about 0% of the air flowrate is received by the cooler bypass line 136).

When the cooler bypass valve 134 is in the open position, the cooler bypass valve 134 is configured to communicate the air to the cooler bypass line 136 and prevent the air from being received by the cooler 130 (e.g., about 0% of the air flowrate is received by the cooler 130 and about 100% of the air flowrate is received by the cooler bypass line 136).

When the cooler bypass valve 134 is in the partially open position, the cooler bypass valve 134 is configured to communicate the air to the cooler 130 and the cooler bypass line 136. The partially open position may include a plurality of positions that determine division of the air received by the cooler 130 and the cooler bypass line 136. For example, the partially open position may include a first position in which about 75% of the air flowrate is received by the cooler 130 and about 25% of the air flowrate is received by the cooler bypass line 136, a second position in which about 50% of the air flowrate is received by the cooler 130 and about 50% of the air flowrate is received by the cooler bypass line 136, a third position in which about 25% of the air flowrate is received by the cooler 130 and about 75% of the air flowrate is received by the cooler bypass line 136, and the like.

The engine system 100 includes a controller 140 electrically or communicatively coupled to the sensor 132 and the cooler bypass valve 134. The controller 140 is configured to control a position of the cooler bypass valve 134 (i.e., select between the closed position, the open position, the partially open position, etc.) based on at least one of the temperature or the moisture level of the air detected by the sensor 132.

In some embodiments, the controller 140 is configured to, when at least one of (i) the moisture level of the air detected by the sensor 132 is equal to or greater than a moisture level threshold, or (ii) the temperature of the air detected by the sensor 132 is less than a temperature threshold, set the cooler bypass valve 134 to the partially open position or the open position such that the at least the portion of the air is communicated from the cooler bypass valve 134 to downstream of the cooler 130 via the cooler bypass line 136.

The controller 140 includes a processing circuit 142. The processing circuit 142 includes a processor 144 and a memory 146. The processor 144 may include a microprocessor, an application-specific integrated circuit (ASIC), a field-programmable gate array (FPGA), etc., or combinations thereof. The memory 146 may include, but is not limited to, electronic, optical, magnetic, or any other storage or transmission device capable of providing a processor, ASIC, FPGA, etc. with program instructions. This memory 146 may include a memory chip, Electrically Erasable Programmable Read-Only Memory (EEPROM), Erasable Programmable Read Only Memory (EPROM), flash memory, or any other suitable memory from which the controller 140 can read instructions. The instructions may include code from any suitable programming language. The memory 146 may include various modules that include instructions which are configured to be implemented by the processor 144.

In various embodiments, the controller 140 is configured to communicate with a central controller (e.g., engine control unit (ECU), engine control module (ECM), etc.) of the engine system 100. In some embodiments, the central controller and the controller 140 are integrated into a single controller.

In some embodiments, the central controller is communicable with a display device (e.g., screen, monitor, touch screen, heads up display (HUD), indicator light, etc.). The display device may be configured to change state in response to receiving information from the central controller and/or the controller 140. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller and/or the controller 140. By changing state, the display device may provide an indication to a user (e.g., operator, etc.) of a status (e.g., operation, in need of service, etc.) of the engine system 100.

The sensor 132 may be real (e.g., physical, etc.) or virtual (e.g., a non-physical sensor that is structured as program logic in the controller 140 that makes various estimations or determinations). For example, a temperature sensor (e.g., the sensor 132) may be a real or virtual sensor arranged to measure or otherwise acquire data, values, or information indicative of a temperature of the air. When structured as a real sensor, the temperature sensor is fluidly coupled to an air conduit, and is structured to send a signal to the controller 140 indicative of the temperature of the air within the air conduit. When structured as a virtual sensor, at least one input may be used by the controller 140 in an algorithm, model, lookup table, etc. to determine or estimate the temperature of the air.

Similar to the temperature sensor, a moisture level sensor (e.g., the sensor 132) may be a real or virtual sensor arranged to measure or otherwise acquire data, values, or information indicative of a moisture level of the air. When structured as a real sensor, the moisture level sensor is fluidly coupled to an air conduit, and is structured to send a signal to the controller 140 indicative of the moisture level of the air within the air conduit. When structured as a virtual sensor, at least one input may be used by the controller 140 in an algorithm, model, lookup table, etc. to determine or estimate the moisture level of the air.

The engine system 100 may include a turbine bypass line 148 fluidly coupled to the second turbine 124 and the exhaust aftertreatment system 170. The turbine bypass line 148 is configured to selectively communicate at least a portion of the exhaust from the second turbine 124 to downstream of the first turbine 114 and upstream of the exhaust aftertreatment system 170.

The controller 140 is electrically or communicatively coupled to the second turbocharger 120. The controller 140 may control the second turbine 124, or a turbine valve within the second turbine 124, to selectively communicate the exhaust from the second turbine 124 to the first turbine 114 and/or the turbine bypass line 148. In some embodiments, the controller 140 may control the second turbine 124 to communicate at least a portion of the exhaust from the second turbine 124 to the turbine bypass line 148 based on load demand requested from the engine 150 and/or the engine system 100. For example, the controller 140 may control the second turbine 124, or the turbine valve within the second turbine 124, to communicate at least a portion of the exhaust from the second turbine 124 to the turbine bypass line 148 (to bypass the first turbine 114) based on the engine 150 operating at low-load, normal-load, non-maximum-load, or idle operating conditions.

In some embodiments, the controller 140 may control the second turbine 124, or the turbine valve within the second turbine 124, to selectively communicate substantially all of the exhaust from the second turbine 124 to the first turbine 114 (e.g., about 100% of the exhaust flowrate is received by the first turbine 114 and about 0% of the exhaust flowrate is received by the turbine bypass line 148, etc.), substantially all of the exhaust from the second turbine 124 to the turbine bypass line 148 (e.g., about 0% of the exhaust flowrate is received by the first turbine 114 and about 100% of the exhaust flowrate is received by the turbine bypass line 148, etc.), and the exhaust from the second turbine 124 equally/unequally divided between the first turbine 114 and the turbine bypass line 148 (e.g., about 50% of the exhaust flowrate is received by the first turbine 114 and about 50% of the exhaust flowrate is received by the turbine bypass line 148, about 10% of the exhaust flowrate is received by the first turbine 114 and about 90% of the exhaust flowrate is received by the turbine bypass line 148, etc.). In some embodiments, the controller 140 is also electrically or communicatively coupled to the first turbocharger 110.

The engine 150 is electrically or communicatively coupled to the controller 140. The controller 140 may control (e.g., set, increase, decrease, maintain, etc.) an engine torque output and/or an engine speed output of the engine 150. The engine 150 may be an internal combustion engine. In some embodiments, the engine 150 may be a hydrogen internal combustion engine. In other embodiments, the engine 150 may be, for example, a diesel internal combustion engine, a gasoline internal combustion engine, a propane internal combustion engine, a dual-fuel internal combustion engine, a natural gas internal combustion engine, etc.

The engine 150 is configured to combust a fuel (e.g., hydrogen, diesel, gasoline, propane, natural gas, compressed natural gas (CNG), etc., or a combination thereof) to produce energy that may be utilized by various outputs. In some embodiments, the fuel includes a combination of diesel and hydrogen. In other embodiments, the fuel includes a combination of diesel and CNG. In yet other embodiments, the fuel includes a combination of gasoline and hydrogen. The engine 150 may produce energy that is utilized to drive a movement member (e.g., wheel, tread, propeller, impeller, turbine, rotor, etc.) or power a generator. The engine 150 may be implemented in a vehicle (e.g., truck, car, construction vehicle, freight vehicle, commercial vehicle, emergency vehicle, military vehicle, maritime vehicle, etc.).

The engine 150 includes one or more cylinders 152. In some embodiments, the engine 150 includes four to eight cylinders 152. For example, as shown in FIGS. 1-3, the engine 150 includes six cylinders 152. In other embodiments, the engine 150 includes up to twenty cylinders 152, with other number of the cylinders 152 also being possible. In some embodiments, as shown in FIGS. 1-3, the engine 150 has an in-line or straight cylinder configuration of the cylinders 152. In other embodiments, the engine 150 has a “V” cylinder configuration, or other cylinder configurations, of the cylinders 152.

In some embodiments, as shown in FIG. 1, the engine 150 includes one or more direct injectors 154 electrically or communicatively coupled to the controller 140 directly and/or via the engine 150. Each of the direct injectors 154 is associated with a corresponding cylinder of the cylinders 152 and is configured to perform direct fuel injection such that the engine 150 utilizes direct injection. In some further embodiments, the fuel includes a combination of diesel and hydrogen or a combination of gasoline and hydrogen that is injected using direct fuel injection.

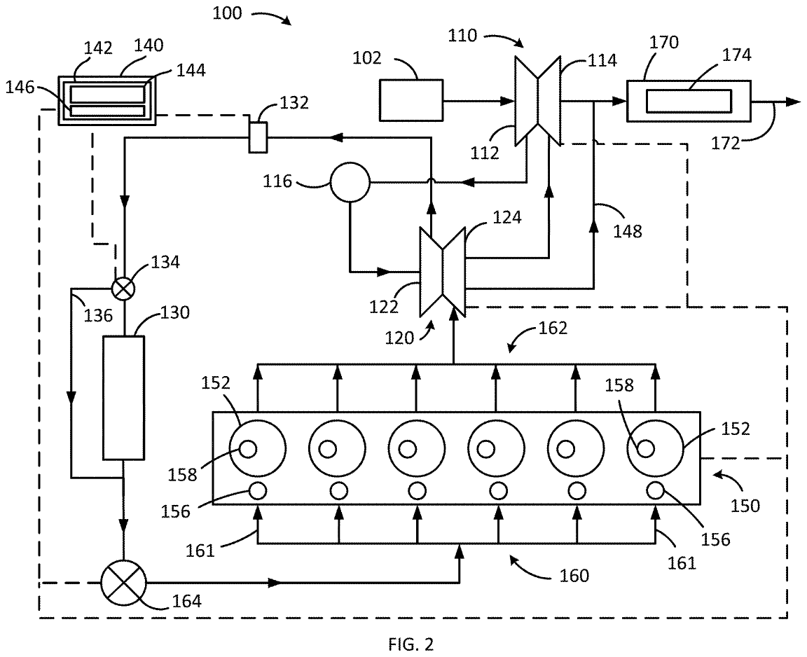

In other embodiments, as shown in FIG. 2, the engine 150 includes one or more port injectors 156 electrically or communicatively coupled to the controller 140 directly and/or via the engine 150. Each of the port injectors 156 is associated with a corresponding cylinder of the cylinders 152 and is configured to perform port fuel injection such that the engine 150 utilizes port fuel injection. In some further embodiments, the fuel includes a combination of diesel and hydrogen or a combination of gasoline and hydrogen that is injected using port fuel injection.

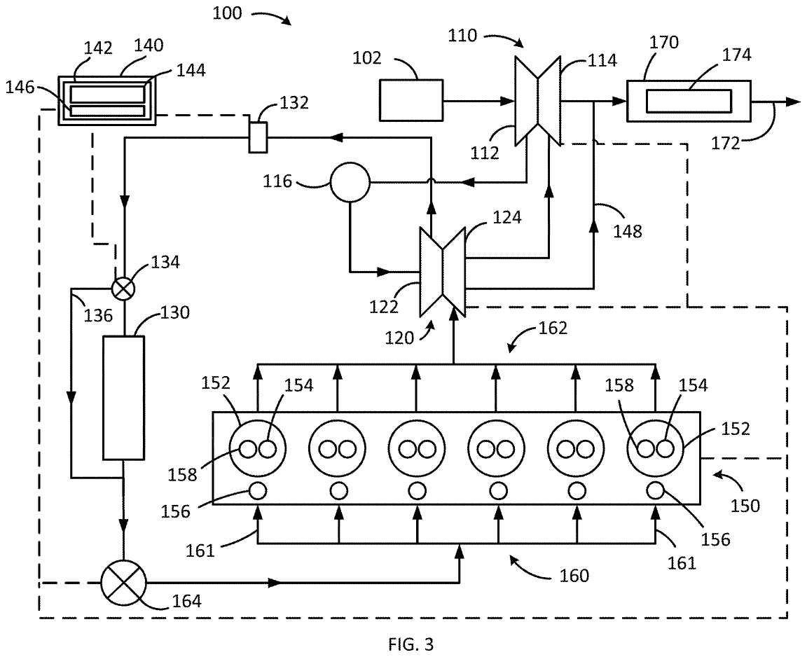

In yet other embodiments, as shown in FIG. 3, the engine 150 includes the direct injectors 154 and the port injectors 156. In these embodiments, the engine 150 may utilize direct injection via the direct injectors 154, port injection via the port injectors 156, or a combination of direct injection via the direct injectors 154 and port injection via the port injectors 156. In some further embodiments, the fuel includes a combination of CNG and hydrogen, where the CNG is injected using port fuel injection and the hydrogen is injected using direct fuel injection.

In some embodiments, the engine 150 includes one or more spark plugs 158 (e.g., igniters, etc.) electrically or communicatively coupled to the controller 140. Each of the spark plugs 158 is disposed at least partially within a corresponding cylinder of the cylinders 152 and is configured to ignite the fuel within the corresponding cylinder.

The engine 150 further includes an intake manifold 160 that is fluidly coupled to the second compressor 122 and configured to receive the air from the second compressor 122. The intake manifold 160 includes one or more intake conduits 161. Each of the intake conduits 161 corresponds to and is fluidly coupled to a corresponding cylinder of the cylinders 152. The engine 150 may include one or more inlet ports. Each of the inlet ports corresponds to a corresponding cylinder of the cylinders 152 and fluidly couples the corresponding cylinder to a corresponding intake conduit of the intake conduits 161. In some embodiments, the cylinders 152, the intake conduits 161, and/or the inlet ports may have a shape that encourages tumble charge motion to improve mixing between the air and the fuel in the cylinders 152, thereby improving combustion stability and efficiency. The engine 150 further includes an exhaust manifold 162 that is fluidly coupled to the second turbine 124 and configured to output the exhaust to the second turbine 124.

The engine system 100 further includes an intake air throttle (IAT) valve 164 disposed downstream of the second compressor 122 and upstream of the engine 150. The IAT valve 164 is electrically or communicatively coupled to the controller 140 and structured to control an amount of air supplied to the engine 150. In some embodiments, the IAT valve 164 is coupled to the intake manifold 160. In some embodiments, the IAT valve 164 is disposed upstream of the intake manifold 160. The IAT valve 164 may be operated by the controller 140 between an open position and a closed position. In the open position, the IAT valve 164 allows a maximum amount of air to flow to the engine 150. In the closed position, the IAT valve 164 prevents or allows a minimum amount of air to flow to the engine 150. The IAT valve 164 may further be operated between a plurality of positions between and/or including the open position and the closed position to adjust the amount of air received by the engine 150.

The exhaust aftertreatment system 170 (e.g., a treatment system, etc.) is configured to treat the exhaust produced by the engine 150 and release a treated exhaust 172 (i.e., the exhaust after being treated). The exhaust aftertreatment system 170 includes the Selective Catalytic Reduction (SCR) catalyst member 174 (e.g., a catalyst member, etc.). The SCR catalyst member 174 is configured to receive a mixture of a treatment fluid (e.g., a reductant (e.g., diesel exhaust fluid (DEF), Adblue®, a urea-water solution (UWS), an aqueous urea solution (e.g., AUS32, etc.), etc.), a hydrocarbon fluid, etc.) from a dosing module and the exhaust from the engine 150 or other components of the exhaust aftertreatment system 170. The treatment fluid droplets undergo the processes of evaporation, thermolysis, and hydrolysis to form non-NOx emissions (e.g., gaseous ammonia, etc.) within the exhaust aftertreatment system 170. The SCR catalyst member 174 is configured to assist in reduction of NOₓ emissions by accelerating a NOₓ reduction process between the treatment fluid and the NOₓ of the exhaust to form diatomic nitrogen, water, and/or carbon dioxide.

In some embodiments, the engine system 100 may include two or more of the exhaust aftertreatment system 170. For example, the engine system 100 may include two exhaust aftertreatment systems 170 that are in parallel (i.e., fluid received or released by a first exhaust aftertreatment system is not received or released by a second exhaust aftertreatment system) or in series (i.e., fluid received or released by the first exhaust aftertreatment system is received or released by the second exhaust aftertreatment system).

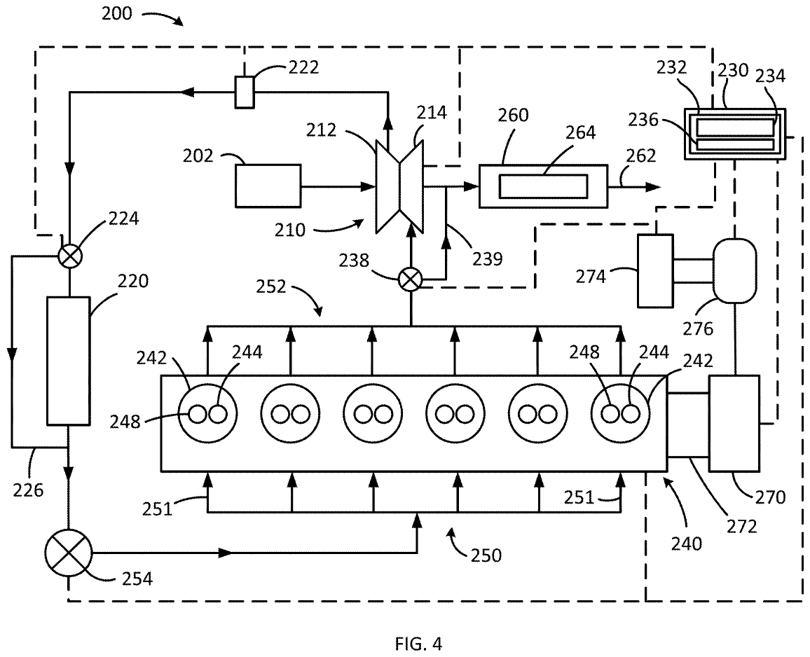

As illustrated in FIGS. 4-6 that depict an engine system 200 (e.g., a second engine system), the engine system 200 comprises a turbocharger 210 comprising a compressor 212 configured to compress air and a turbine 214 coupled to the compressor 212 and configured to transfer energy from an exhaust to the compressor 212. The engine system 200 further comprises an engine 240 disposed downstream of the compressor 212. The engine 240 is configured to receive the air from the compressor 212, combust a mixture of the air and fuel, provide the exhaust based on combustion of the mixture to the turbine 214, and generate an engine torque output. The engine system 200 further comprises an exhaust aftertreatment system 260 disposed downstream of the turbine 214. The exhaust aftertreatment system 260 is configured to receive the exhaust from the turbine 214 and treat the exhaust. The exhaust aftertreatment system 260 comprises a selective catalytic reduction catalyst member 264. The engine system 200 further comprises a motor 270 coupled to an engine system component via a coupling mechanism 272. The motor 270 is configured to generate a motor torque output. A total torque output comprises the engine torque output generated by the engine 240 and the motor torque output generated by the motor 270.

The engine system 200 may include an air source 202 (e.g., air intake, atmosphere, air cooler, etc.) disposed upstream of the compressor 212 and configured to provide the air to the compressor 212.

In some embodiments, the engine system 200 may additional turbochargers in addition to the turbocharger 210. In some embodiments, the turbocharger 210 is a high-pressure turbocharger. In some embodiments, the turbocharger 210 is a variable-geometry or a wastegate turbocharger. The turbocharger 210 (i.e., utilization of the compressor 212 to compress the air) may provide the benefit of increasing an amount of air that can be delivered to the engine 240, thereby allowing for higher air-to-fuel ratios required by particular fuels (e.g., hydrogen, etc.) and/or allowing for increased injection amounts of fuel (e.g., fuel volume) while maintaining substantially stochiometric combustion to increase the power generated at the combustion stroke. As such, transient response performance (e.g., rise time, delay time, settling time, etc.) of the engine 240 may be improved, particularly at low idle operating condition of the engine 240.

The engine system 200 may include a cooler 220 (e.g., a charge air cooler (CAC), etc.) that is substantially similar to the cooler 130 of the engine system 100. The cooler 220 is disposed downstream of the compressor 212 and upstream of the engine 240. The cooler 220 is configured to receive the air from the compressor 212, cool the air, and output the air (e.g., cooled air) to the engine 240, such that a temperature of the air (e.g., a first air temperature) received by the cooler 220 is higher than a temperature of the air (e.g., a second air temperature) released from the cooler 220.

The engine system 200 may include a sensor 222 that is substantially similar to the sensor 132 of the engine system 100. The sensor 222 is disposed downstream of the compressor 212 and upstream of the cooler 220. The sensor 222 is configured to detect at least one of a temperature or a moisture level of the air provided by the compressor 212.

The engine system 200 may further include a cooler bypass valve 224 that is substantially similar to the cooler bypass valve 134 of the engine system 100. The cooler bypass valve 224 is disposed downstream of the sensor 222 and upstream of the cooler 220. The cooler bypass valve 224 is configured to selectively adjust a flowrate of the air received by the cooler 220.

The engine system 200 may further include a cooler bypass line 226 that is substantially similar to the cooler bypass line 136 of the engine system 100. The cooler bypass line 226 is fluidly coupled to the cooler bypass valve 224. The cooler bypass line 226 is configured to, when the cooler bypass valve 224 is not in a closed position (e.g., an open position, a partially open position, etc.), communicate at least a portion of the air from the cooler bypass valve 224 to downstream of the cooler 220, thereby bypassing the cooler 220.

When the cooler bypass valve 224 is in the closed position, the cooler bypass valve 224 is configured to communicate the air to the cooler 220 and prevent the air from being received by the cooler bypass line 226 (e.g., about 100% of the air flowrate is received by the cooler 220 and about 0% of the air flowrate is received by the cooler bypass line 226).

When the cooler bypass valve 224 is in the open position, the cooler bypass valve 224 is configured to communicate the air to the cooler bypass line 226 and prevent the air from being received by the cooler 220 (e.g., about 0% of the air flowrate is received by the cooler 220 and about 100% of the air flowrate is received by the cooler bypass line 226).

When the cooler bypass valve 224 is in the partially open position, the cooler bypass valve 224 is configured to communicate the air to the cooler 220 and the cooler bypass line 226. The partially open position may include a plurality of positions that determine division of the air received by the cooler 220 and the cooler bypass line 226. For example, the partially open position may include a first position in which about 75% of the air flowrate is received by the cooler 220 and about 25% of the air flowrate is received by the cooler bypass line 226, a second position in which about 50% of the air flowrate is received by the cooler 220 and about 50% of the air flowrate is received by the cooler bypass line 226, a third position in which about 25% of the air flowrate is received by the cooler 220 and about 75% of the air flowrate is received by the cooler bypass line 226, and the like.

The engine system 200 includes a controller 230 that may be substantially similar to the controller 140 of the engine system 100. The controller 230 is electrically or communicatively coupled to the sensor 222 and the cooler bypass valve 224. The controller 230 is configured to control a position of the cooler bypass valve 224 (i.e., select between the closed position, the open position, the partially open position, etc.) based on at least one of the temperature or the moisture level of the air detected by the sensor 222.

In some embodiments, the controller 230 is configured to, when at least one of (i) the moisture level of the air detected by the sensor 222 is equal to or greater than a moisture level threshold, or (ii) the temperature of the air detected by the sensor 222 is less than a temperature threshold, set the cooler bypass valve 224 to the partially open position or the open position such that the at least the portion of the air is communicated from the cooler bypass valve 224 to downstream of the cooler 220 via the cooler bypass line 226.

The controller 230 includes a processing circuit 232. The processing circuit 232 includes a processor 234 and a memory 236. The processor 234 may include a microprocessor, an application-specific integrated circuit (ASIC), a field-programmable gate array (FPGA), etc., or combinations thereof. The memory 236 may include, but is not limited to, electronic, optical, magnetic, or any other storage or transmission device capable of providing a processor, ASIC, FPGA, etc. with program instructions. This memory 236 may include a memory chip, Electrically Erasable Programmable Read-Only Memory (EEPROM), Erasable Programmable Read Only Memory (EPROM), flash memory, or any other suitable memory from which the controller 230 can read instructions. The instructions may include code from any suitable programming language. The memory 236 may include various modules that include instructions which are configured to be implemented by the processor 234.

In various embodiments, the controller 230 is configured to communicate with a central controller (e.g., engine control unit (ECU), engine control module (ECM), etc.) of the engine system 200. In some embodiments, the central controller and the controller 230 are integrated into a single controller.

In some embodiments, the central controller is communicable with a display device (e.g., screen, monitor, touch screen, heads up display (HUD), indicator light, etc.). The display device may be configured to change state in response to receiving information from the central controller and/or the controller 230. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller and/or the controller 230. By changing state, the display device may provide an indication to a user (e.g., operator, etc.) of a status (e.g., operation, in need of service, etc.) of the engine system 200.

The sensor 222 may be real (e.g., physical, etc.) or virtual (e.g., a non-physical sensor that is structured as program logic in the controller 230 that makes various estimations or determinations). For example, a temperature sensor (e.g., the sensor 222) may be a real or virtual sensor arranged to measure or otherwise acquire data, values, or information indicative of a temperature of the air. When structured as a real sensor, the temperature sensor is fluidly coupled to an air conduit, and is structured to send a signal to the controller 230 indicative of the temperature of the air within the air conduit. When structured as a virtual sensor, at least one input may be used by the controller 230 in an algorithm, model, lookup table, etc. to determine or estimate the temperature of the air.

Similar to the temperature sensor, a moisture level sensor (e.g., the sensor 222) may be a real or virtual sensor arranged to measure or otherwise acquire data, values, or information indicative of a moisture level of the air. When structured as a real sensor, the moisture level sensor is fluidly coupled to an air conduit and is structured to send a signal to the controller 230 indicative of the moisture level of the air within the air conduit. When structured as a virtual sensor, at least one input may be used by the controller 230 in an algorithm, model, lookup table, etc. to determine or estimate the moisture level of the air.

The engine system 200 may include a turbine bypass valve 238 that is electrically or communicatively coupled to the controller 230. The turbine bypass valve 238 is disposed downstream of the engine 240 and upstream of the turbine 214. The turbine bypass valve 238 is configured to selectively adjust a flowrate of the exhaust received by the turbine 214.

The engine system 200 may include a turbine bypass line 239 fluidly coupled to turbine bypass valve 238. The turbine bypass line 239 is configured to, when the turbine bypass valve 238 is not in a closed position (e.g., an open position, a partially open position, etc.), communicate at least a portion of the exhaust from the turbine bypass valve 238 to downstream of the turbine 214 and upstream of the exhaust aftertreatment system 260 via the turbine bypass line 239, thereby bypassing the turbine 214.

When the turbine bypass valve 238 is in the closed position, the turbine bypass valve 238 is configured to communicate the exhaust to the turbine 214 and prevent the exhaust from being received by the turbine bypass line 239 (e.g., about 100% of the exhaust flowrate is received by the turbine 214 and about 0% of the exhaust flowrate is received by the turbine bypass line 239).

When the turbine bypass valve 238 is in the open position, the turbine bypass valve 238 is configured to communicate the exhaust to the turbine bypass line 239 and prevent the exhaust from being received by the turbine 214 (e.g., about 0% of the exhaust flowrate is received by the turbine 214 and about 100% of the exhaust flowrate is received by the turbine bypass line 239).

When the turbine bypass valve 238 is in the partially open position, the turbine bypass valve 238 is configured to communicate the exhaust to the turbine 214 and the turbine bypass valve 238. The partially open position may include a plurality of positions that determine division of the exhaust received by the turbine 214 and the turbine bypass valve 238. For example, the partially open position may include a first position in which about 75% of the exhaust flowrate is received by the turbine 214 and about 25% of the exhaust flowrate is received by the turbine bypass valve 238, a second position in which about 50% of the exhaust flowrate is received by the turbine 214 and about 50% of the exhaust flowrate is received by the turbine bypass valve 238, a third position in which about 25% of the exhaust flowrate is received by the turbine 214 and about 75% of the exhaust flowrate is received by the turbine bypass valve 238, and the like.

In some embodiments, the controller 230 may control the turbine bypass valve 238 to communicate at least a portion of the exhaust from the engine 240 to the turbine bypass line 239 based on load demand requested from the engine 240 and/or the engine system 200. For example, the controller 230 may control the turbine bypass valve 238 to communicate at least a portion of the exhaust from the engine 240 to the turbine bypass line 239 based on the engine 240 operating at low-load, normal-load, non-maximum-load, or idle operating conditions.

The engine 240 is electrically or communicatively coupled to the controller 230. The controller 230 may control (e.g., set, increase, decrease, maintain, etc.) an engine torque output and/or an engine speed output of the engine 240. The engine 240 may be substantially similar to the engine 150 of the engine system 100. The engine 240 may be an internal combustion engine. In some embodiments, the engine 240 may be a hydrogen internal combustion engine. In other embodiments, the engine 240 may be, for example, a diesel internal combustion engine, a gasoline internal combustion engine, a propane internal combustion engine, a dual-fuel internal combustion engine, a natural gas internal combustion engine, etc.

The engine 240 is configured to combust a fuel (e.g., hydrogen, diesel, gasoline, propane, natural gas, CNG, etc., or a combination thereof) to produce energy that may be utilized by various outputs. In some embodiments, the fuel includes a combination of diesel and hydrogen. In other embodiments, the fuel includes a combination of diesel and CNG. In yet other embodiments, the fuel includes a combination of gasoline and hydrogen. The engine 240 may produce energy that is utilized to drive a movement member (e.g., wheel, tread, propeller, impeller, turbine, rotor, etc.) or power a generator. The engine 240 may be implemented in a vehicle (e.g., truck, car, construction vehicle, freight vehicle, commercial vehicle, emergency vehicle, military vehicle, maritime vehicle, etc.).

The engine 240 includes one or more cylinders 242 that are substantially similar to the cylinders 152 of the engine 150. In some embodiments, the engine 240 includes four to eight cylinders 242. For example, as shown in FIGS. 4-6, the engine 240 includes six cylinders 242. In other embodiments, the engine 240 includes up to twenty cylinders 242, with other number of the cylinders 242 also being possible. In some embodiments, as shown in FIGS. 4-6, the engine 240 has an in-line or straight cylinder configuration of the cylinders 242. In other embodiments, the engine 240 has a “V” cylinder configuration, or other cylinder configurations, of the cylinders 242.

In some embodiments, as shown in FIG. 4, the engine 240 includes one or more direct injectors 244 electrically or communicatively coupled to the controller 230 directly and/or via the engine 240. Each of the direct injectors 244 is associated with a corresponding cylinder of the cylinders 242 and is configured to perform direct fuel injection such that the engine 240 utilizes direct injection. In some further embodiments, the fuel includes a combination of diesel and hydrogen or a combination of gasoline and hydrogen that is injected using direct fuel injection.

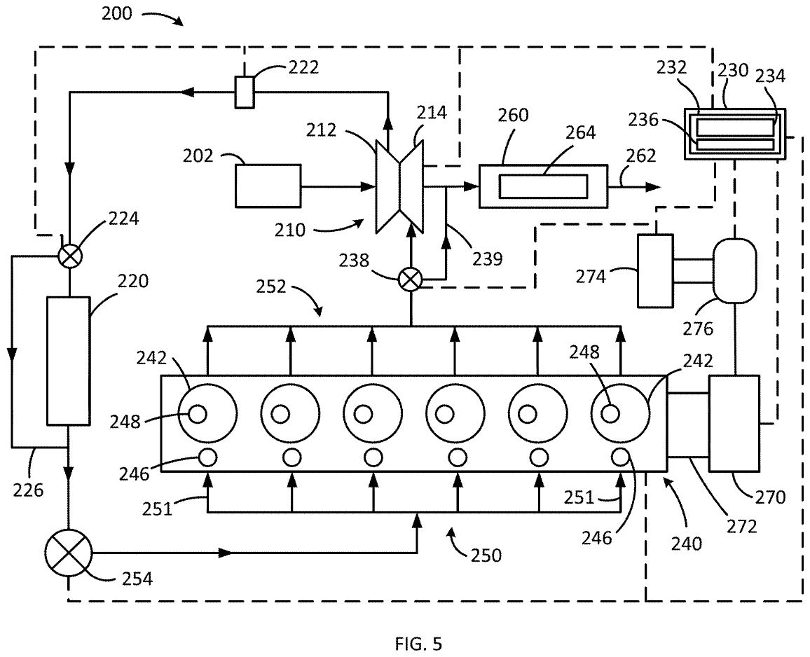

In other embodiments, as shown in FIG. 5, the engine 240 includes one or more port injectors 246 electrically or communicatively coupled to the controller 230 directly and/or via the engine 240. Each of the port injectors 246 is associated with a corresponding cylinder of the cylinders 242 and is configured to perform port fuel injection such that the engine 240 utilizes port fuel injection. In some further embodiments, the fuel includes a combination of diesel and hydrogen or a combination of gasoline and hydrogen that is injected using port fuel injection.

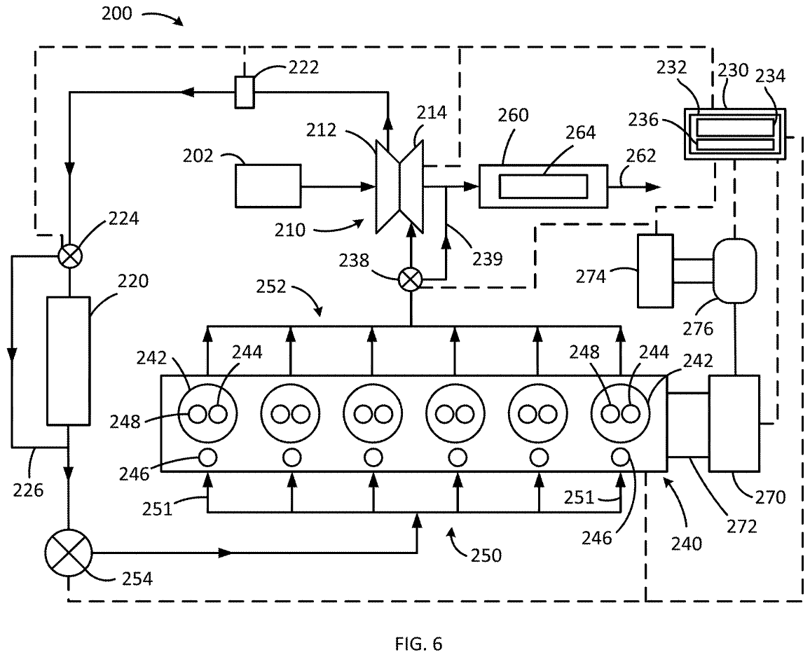

In yet other embodiments, as shown in FIG. 6, the engine 240 includes the direct injectors 244 and the port injectors 246. In these embodiments, the engine 240 may utilize direct injection via the direct injectors 244, port injection via the port injectors 246, or a combination of direct injection via the direct injectors 244 and port injection via the port injectors 246. In some further embodiments, the fuel includes a combination of CNG and hydrogen, where the CNG is injected using port fuel injection and the hydrogen is injected using direct fuel injection.

In some embodiments, the engine 240 includes one or more spark plugs 248 (e.g., igniters, etc.) electrically or communicatively coupled to the controller 230 directly and/or via the engine 240. Each of the spark plugs 248 is disposed at least partially within a corresponding cylinder of the cylinders 242 and is configured to ignite the fuel within the corresponding cylinder.

The engine 240 further includes an intake manifold 250 that is fluidly coupled to the compressor 212 and configured to receive the air from the compressor 212. The intake manifold 250 includes one or more intake conduits 251. Each of the intake conduits 251 corresponds to and is fluidly coupled to a corresponding cylinder of the cylinders 242. The engine 240 may include one or more inlet ports. Each of the inlet ports corresponds to a corresponding cylinder of the cylinders 242 and fluidly couples the corresponding cylinder to a corresponding intake conduit of the intake conduits 251. In some embodiments, the cylinders 242, the intake conduits 251, and/or the inlet ports may have a shape that encourages tumble charge motion to improve mixing between the air and the fuel in the cylinders 242, thereby improving combustion stability and efficiency. The engine 240 further includes an exhaust manifold 252 that is fluidly coupled to the turbine 214 and configured to output the exhaust to the turbine 214.

The engine system 200 further includes an IAT valve 254 that is substantially similar to the IAT valve 164. The IAT valve 254 is disposed downstream of the compressor 212 and upstream of the engine 240. The IAT valve 254 is electrically or communicatively coupled to the controller 230 and structured to control an amount of air supplied to the engine 240. In some embodiments, the IAT valve 254 is coupled to the intake manifold 250. In some embodiments, the IAT valve 254 is disposed upstream of the intake manifold 250. The IAT valve 254 may be operated by the controller 230 between an open position and a closed position. In the open position, the IAT valve 254 allows a maximum amount of air to flow to the engine 240. In the closed position, the IAT valve 254 prevents or allows a minimum amount of air to flow to the engine 240. The IAT valve 254 may further be operated between a plurality of positions between and/or including the open position and the closed position to adjust the amount of air received by the engine 240.

The exhaust aftertreatment system 260 (e.g., a treatment system, etc.) may be substantially similar to the exhaust aftertreatment system 170 of the engine system 100. The exhaust aftertreatment system 260 is configured to treat the exhaust produced by the engine 240 and release a treated exhaust 262 (i.e., the exhaust after being treated). The exhaust aftertreatment system 260 includes the Selective Catalytic Reduction (SCR) catalyst member 264 (e.g., a catalyst member, etc.). The SCR catalyst member 264 may be substantially similar to the SCR catalyst member 174 of the exhaust aftertreatment system 170. The SCR catalyst member 264 is configured to receive a mixture of a treatment fluid (e.g., a reductant (e.g., DEF, Adblue®, UWS, an aqueous urea solution (e.g., AUS32, etc.), etc.), a hydrocarbon fluid, etc.) from a dosing module and the exhaust from the engine 240 or other components of the exhaust aftertreatment system 260. The treatment fluid droplets undergo the processes of evaporation, thermolysis, and hydrolysis to form non-NOx emissions (e.g., gaseous ammonia, etc.) within the exhaust aftertreatment system 260. The SCR catalyst member 264 is configured to assist in reduction of NOₓ emissions by accelerating a NOₓ reduction process between the treatment fluid and the NOₓ of the exhaust to form diatomic nitrogen, water, and/or carbon dioxide.

In some embodiments, the engine system 200 may include two or more of the exhaust aftertreatment system 260. For example, the engine system 200 may include two exhaust aftertreatment systems 260 that are in parallel (i.e., fluid received or released by a first exhaust aftertreatment system is not received or released by a second exhaust aftertreatment system) or in series (i.e., fluid received or released by the first exhaust aftertreatment system is received or released by the second exhaust aftertreatment system).

The engine system 200 may be a hybrid engine system that utilizes the engine 240 and an electromagnetic device (e.g., the motor 270 (e.g., an electric motor, etc.)) to provide a total torque output and/or a total speed output. The electromagnetic device, e.g., the motor 270, may be a motor, a motor-generator, a generator, or the like. The motor 270 is electrically or communicatively coupled to the controller 230. The controller 230 is configured to control the motor torque output generated by the motor 270 based on at least one of a torque demand requested, or predicted to be requested, from the engine 240 and/or the engine system 200 or a mass air fuel ratio demand requested, or predicted to be requested, from the engine 240 and/or the engine system 200.

The coupling mechanism 272 (e.g., drive mechanism, etc.) is structured to selectively mechanically couple the motor 270 to the engine 240 and/or a component of the engine system 200, e.g., an engine system component, (e.g., the engine 240, a transmission, an axle, etc.). The coupling mechanism 272 may include a clutch operable between (i) an engaged state in which the motor 270 is capable of contributing to a total torque output of the engine system 200 and (ii) a disengaged state in which the motor 270 is incapable of contributing to the total torque output of the engine system 200. The engine 240 and the motor 270 may provide the total torque output to a driveshaft, where the total torque output includes the engine torque output generated by the engine 240 and the motor torque output generated by the motor 270.

In some embodiments, the coupling mechanism 272 is coupled to the engine 240, such that the motor 270 is configured to selectively supply the motor torque output to a flywheel of the engine 240. In other embodiments, the coupling mechanism 272 is coupled to a transmission of the engine system 200, such that the motor 270 is configured to selectively supply the motor torque output to gears of the transmission. In yet other embodiments, the coupling mechanism 272 is coupled to an axle of the engine system 200, such that the motor 270 is configured to selectively supply the motor torque output to gears of the axle.

The engine system 200 includes a battery 274 (e.g., a high capacity battery, a high voltage battery, a lithium-ion battery, etc.) electrically or communicatively coupled to the controller 230 and the motor 270. The battery 274 is configured to provide electrical energy to power the motor 270 and/or receive electrical energy from the motor 270 (i.e., the motor 270 is configured as a motor-generator or a generator device).

The engine system 200 may include an Alternating Current (AC)/Direct Current (DC) convertor 276 electrically or communicatively coupled to the controller 230, the motor 270, and the battery 274. The AC/DC convertor 276 is configured to convert current transferred between the battery 274 and the motor 270, such that the motor 270 receives AC current and the battery 274 receives DC current.

In some embodiments, the controller 230 is configured to, when the torque demand is less than or equal to the engine torque output, operate the motor 270 such that the motor torque output is less than or equal to zero. In some examples, when the torque demand is equal to the engine torque output, the controller 230 may be configured to operate the motor 270 at an off state or an idle state such that the motor torque output is substantially equal to zero. In some examples, when the torque demand is less than the engine torque output, the controller 230 may be configured to operate the motor 270 at a generator state to utilize additional engine torque output (i.e., difference between the engine torque output and the torque demand) of the engine 240 to charge the battery 274 via motor 270 such that the motor torque output is less than zero.

In some embodiments, the controller 230 is configured to, when the torque demand is greater than the engine torque output, operate the motor 270 such that the motor torque output is greater than zero and the total torque output is equal to or greater than the torque demand.

In some examples, the controller 230 is configured to, when the torque demand is greater than the engine torque output, operate the motor 270 such that the motor torque output is greater than zero and the total torque output is equal to or greater than the torque demand until the engine torque output increases and becomes equal to or greater than the torque demand. As such, transient response performance (e.g., rise time, delay time, settling time, etc.) of the engine 240 and/or the engine system 200 may be improved via the motor 270, particularly at low idle operating condition of the engine 240.

In some examples, the controller 230 is configured to, when the torque demand is greater than the engine torque output, operate the motor 270 such that the motor torque output is greater than zero and the total torque output is equal to or greater than the torque demand, where (i) the engine 240 is incapable of increasing the engine torque output to become equal to or greater than the torque demand or (ii) the engine torque output of the engine 240 is configured by the controller 230 to not become equal to or greater than the torque demand. As such, the motor 270 may improve the total torque output capabilities of the engine system 200, improve fuel efficiency of the engine 240, and/or increase lifespan of the engine 240 by reducing usage of and/or load on the engine 240.

In some embodiments, the controller 230 is configured to, when the mass air fuel ratio demand is less than or equal to a mass air fuel ratio available to the engine 240, operate the motor 270 such that the motor torque output is less than or equal to zero. The mass air fuel ratio available is associated with the engine torque output. For example, the mass air fuel ratio available may be associated with the engine speed output, where the engine speed output is associated with the engine torque output.

In some examples, when the mass air fuel ratio demand is equal to the mass air fuel ratio available, the controller 230 may be configured to operate the motor 270 at the off state or the idle state such that the motor torque output is substantially equal to zero. In some examples, when the mass air fuel ratio demand is less than the mass air fuel ratio available, the controller 230 may be configured to operate the motor 270 at the generator state to utilize the additional engine torque output associated with the additional mass air fuel ratio available (i.e., difference between the mass air fuel ratio available and the mass air fuel ratio demand) of the engine 240 to charge the battery 274 via motor 270 such that the motor torque output is less than zero.

In some embodiments, the controller 230 is configured to, when the mass air fuel ratio demand is greater than the mass air fuel ratio available, operate the motor 270 such that the motor torque output is greater than zero and the total torque output is equal to or greater than the torque demand.

In some examples, the controller 230 is configured to, when the mass air fuel ratio demand is greater than the mass air fuel ratio available, operate the motor 270 such that the motor torque output is greater than zero and the total torque output is equal to or greater than the torque demand until the engine torque output increases and becomes equal to or greater than the torque demand. As such, the transient response performance (e.g., rise time, delay time, settling time, etc.) of the engine 240 and/or the engine system 200 may be improved via the motor 270, particularly at low idle operating condition of the engine 240.

In some examples, the controller 230 is configured to, when the mass air fuel ratio demand is greater than the mass air fuel ratio available, operate the motor 270 such that the motor torque output is greater than zero and the total torque output is equal to or greater than the torque demand, where (i) the engine 240 is incapable of increasing the engine torque output to become equal to or greater than the torque demand or (ii) the engine torque output of the engine 240 is configured by the controller 230 to not become equal to or greater than the torque demand. As such, the motor 270 may improve the total torque output capabilities of the engine system 200, improve fuel efficiency of the engine 240, and/or increase lifespan of the engine 240 by reducing usage of and/or load on the engine 240.

In some embodiments, the engine system 200 includes a fuel source (e.g., a fuel container, a fuel line, etc.) that provides fuel to the engine 240. The engine system 200 may further include a fuel sensor electrically or communicatively coupled to the controller 230, disposed within or proximate to the fuel source, and configured to detect a quantity of fuel (e.g., a mass of fuel, a volume of fuel, etc.) available in the fuel source. In some embodiments, the controller 230 is configured to operate the motor 270 such that the motor torque output is greater than zero based on the quantity of the fuel detected by the fuel sensor being less than or equal to a fuel quantity threshold. As such, the motor 270 may improve an operating time performance and/or distance range performance of the engine system 200.

The engine system 200 may include a prediction system configured to predict an increase in load demand (e.g., increase in torque demand, increase in mass air fuel ratio demand, etc.) before the increase in the load demand is partially or fully requested from the engine 240 and/or the engine system 200. The prediction system may predict the increase in the load demand based on driveline readiness of the engine 240, engine speed output of the engine 240, rotational speed of the compressor 212 and/or the turbine 214, ground terrain, grade, etc. The prediction system may include and/or utilize various components to predict the increase in the load demand, such as sensors that take measurements of the engine 240, compressor 212, turbine 214, etc., a Global Positioning System (GPS) that determines a location of the engine system 200 and surrounding areas, a Laser Imaging, Detection, and Ranging (LIDAR) sensor, etc.

In some embodiments, the controller 230 is configured to operate the motor 270 such that the motor torque output is greater than zero based on the prediction system predicting an increase in the load demand, before the increase in the load demand is at least one of partially or fully requested from the engine 240 and/or the engine system 200.

The engine system 200 may include three modes of operation. In a first mode of operation, the total torque output to the driveshaft (e.g., driveline torque) is supplied solely by the engine 240 (i.e., the motor 270 does not contribute to the driveline torque (e.g., the motor 270 is disengaged via the coupling mechanism 272, the motor torque output is substantially equal to zero, etc.)). In a second mode of operation, the total torque output to the driveshaft is supplied solely by the motor 270 (i.e., the engine 240 does not contribute to the driveline torque (e.g., the engine torque output is substantially zero, etc.)). In a third mode of operation, the total torque output to the driveshaft is supplied by both the engine 240 and the motor 270. In the third mode of operation, the controller 230 may be configured to operate the motor 270 such that the motor torque output is greater than zero to improve the transient response performance of the engine 240 and/or the engine system 200.

It is to be appreciated that the engine system 100 and/or components of the engine system 100 (e.g., the first turbocharger 110, the second turbocharger 120, etc.) may be combined with the engine system 200 and/or components of the engine system 200 (e.g., the turbocharger 210, the motor 270, the battery 274, etc.).

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the present disclosure.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, exhaust gas, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. An engine system comprising:
a first turbocharger comprising:
a first compressor configured to compress air, and
a first turbine coupled to the first compressor and configured to transfer energy from an exhaust to the first compressor;
a second turbocharger comprising:
a second compressor disposed downstream of the first compressor, the second compressor configured to receive the air from the first compressor and compress the air, and
a second turbine coupled to the second compressor and disposed upstream of the first turbine, the second turbine configured to transfer energy from the exhaust to the second compressor; and
an engine disposed downstream of the second compressor, the engine configured to receive the air from the second compressor, combust a mixture of the air and fuel, and provide the exhaust based on combustion of the mixture to the second turbine.

2. The engine system of claim 1, wherein the engine utilizes direct injection.

3. The engine system of claim 1, wherein the engine utilizes port injection.

4. The engine system of claim 1, wherein the engine utilizes a combination of direct injection and port injection.

5. The engine system of claim 1, wherein the first turbocharger is a low-pressure turbocharger and the second turbocharger is a high-pressure turbocharger.

6. The engine system of claim 1, further comprising an intercooler disposed downstream of the first compressor and upstream of the second compressor.

7. The engine system of claim 1, further comprising a cooler disposed downstream of the second compressor.

8. The engine system of claim 7, further comprising:
a cooler bypass valve disposed downstream of the second compressor and upstream of the cooler, the cooler bypass valve configured to selectively adjust a flowrate of the air received by the cooler; and
a cooler bypass line fluidly coupled to the cooler bypass valve, the cooler bypass line configured to, when the cooler bypass valve is not in a closed position, communicate at least a portion of the air from the cooler bypass valve to downstream of the cooler.

9. The engine system of claim 8, further comprising:
a sensor disposed downstream of the second compressor and upstream of the cooler bypass valve, the sensor configured to detect at least one of a temperature or a moisture level of the air provided by the second compressor; and
a controller communicatively coupled to the sensor and the cooler bypass valve, the controller configured to control a position of the cooler bypass valve based on at least one of the temperature or the moisture level of the air detected by the sensor.

10. The engine system of claim 9, wherein the controller is further configured to, when at least one of (i) the moisture level of the air detected by the sensor is equal to or greater than a moisture level threshold, or (ii) the temperature of the air detected by the sensor is less than a temperature threshold, set the cooler bypass valve to a partially open position or an open position such that the at least the portion of the air is communicated from the cooler bypass valve to downstream of the cooler via the cooler bypass line.

11. The engine system of claim 10, wherein the controller is configured to set the cooler bypass valve to the partially open position or the open position when the moisture level of the air detected by the sensor is equal to or greater than the moisture level threshold and the temperature of the air detected by the sensor is less than the temperature threshold.

12. The engine system of claim 1, further comprising an exhaust aftertreatment system disposed downstream of the first turbine, the exhaust aftertreatment system configured to receive the exhaust from the first turbine and treat the exhaust, the exhaust aftertreatment system comprising a selective catalytic reduction catalyst member.

13. The engine system of claim 12, further comprising a turbine bypass line fluidly coupled to the second turbine and the exhaust aftertreatment system, the turbine bypass line configured to selectively communicate at least a portion of the exhaust from the second turbine to downstream of the first turbine and upstream of the exhaust aftertreatment system.

14. An engine system comprising:
a first compressor configured to compress air;
a second compressor disposed downstream of the first compressor, the second compressor configured to receive the air from the first compressor and compress the air;
an engine disposed downstream of the second compressor, the engine configured to receive the air from the second compressor, combust a mixture of the air and fuel, and provide exhaust based on combustion of the mixture; and
an exhaust aftertreatment system disposed downstream of the engine, the exhaust aftertreatment system configured to receive and treat the exhaust, the exhaust aftertreatment system comprising a selective catalytic reduction catalyst member.

15. An engine system comprising:
a turbocharger comprising:
a compressor configured to compress air, and
a turbine coupled to the compressor and configured to transfer energy from an exhaust to the compressor;
an engine disposed downstream of the compressor, the engine configured to receive the air from the compressor, combust a mixture of the air and fuel, provide the exhaust based on combustion of the mixture to the turbine, and generate an engine torque output;
an exhaust aftertreatment system disposed downstream of the turbine, the exhaust aftertreatment system configured to receive the exhaust from the turbine and treat the exhaust, the exhaust aftertreatment system comprising a selective catalytic reduction catalyst member; and
a motor coupled to an engine system component via a coupling mechanism, the motor configured to generate a motor torque output, wherein a total torque output comprises the engine torque output generated by the engine and the motor torque output generated by the motor.

16. The engine system of claim 15, further comprising a controller communicatively coupled to the motor, the controller configured to control the motor torque output generated by the motor based on at least one of a torque demand or a mass air fuel ratio demand.

17. The engine system of claim 16, wherein the controller is further configured to:
when the torque demand is less than or equal to the engine torque output, operate the motor such that the motor torque output is less than or equal to zero; and
when the torque demand is greater than the engine torque output, operate the motor such that the motor torque output is greater than zero and the total torque output is equal to or greater than the torque demand.

18. The engine system of claim 16, wherein the controller is further configured to:
when the mass air fuel ratio demand is less than or equal to a mass air fuel ratio available to the engine, the mass air fuel ratio available associated with the engine torque output, operate the motor such that the motor torque output is less than or equal to zero; and
when the mass air fuel ratio demand is greater than the mass air fuel ratio available, operate the motor such that the motor torque output is greater than zero and the total torque output is equal to or greater than the torque demand.

19. The engine system of claim 15, wherein the engine system component comprises at least one of the engine, a transmission, or an axle.

20. The engine system of claim 15, further comprising:
a turbine bypass valve disposed downstream of the engine and upstream of the turbine, the turbine bypass valve configured to selectively adjust a flowrate of the exhaust received by the turbine; and
a turbine bypass line fluidly coupled to the turbine bypass valve, the turbine bypass line configured to, when the turbine bypass valve is not in a closed position, communicate at least a portion of the exhaust from the turbine bypass valve to downstream of the turbine and upstream of the exhaust aftertreatment system.
